(19) United States
(12) Patent Application Publication
(10) Pub. No.: US 2007/0200980 A1
(43) Pub. Date: Aug. 30, 2007

(54) Color display device

(76) Inventor: Takakazu Fukuchi, Chiba-shi (JP)

Correspondence Address: BRUCE L. ADAMS, ESQ., SUITE 1231, 17 BATTERY PLACE, NEW YORK, NY, 10004, US

(21) Appl. No.: 11/705,679

(22) Filed: Feb. 13, 2007

(30) Foreign Application Priority Data
Feb. 27, 2006 (JP) 2006-049699

(51) Int. Cl. G02F 1/1335

(52) U.S. Cl. 349/106

(57) ABSTRACT

Provided is a color filter substrate in which satisfactory planarity at any portion on a black matrix is materialized. In a color filter substrate used in the present invention, a planarizing layer is formed so as to cover a light shielding layer (12) having a black matrix (41) and colored layers. The colored layers are partitioned into shapes corresponding to the shape of the black matrix (41), edges of the respective partitioned colored layers (16R, 16G, and 16B) overlap the light shielding layer (12), the edges have spaced portions (43) formed therebetween so that the edges are distance from each other, and the planarizing layer is formed over the light shielding layer (12) so as to fill the spaced portions (43).

### BACKGROUND OF THE INVENTION

1. Field of the Invention

The present invention relates to a color liquid crystal display device used for a portable information device such as a cellular telephone or an electronic personal organizer, a monitor of a personal computer, or the like. More particularly, the present invention relates to a color filter substrate used for the color liquid crystal display device and a method of manufacturing the color filter substrate.

2. Description of the Related Art

Conventionally, as a color filter substrate used for a color liquid crystal display device, one in which a color filter of three colors such as RGB is formed on a black matrix in a lattice shape for preventing color mixture and is covered with a planarizing layer is known. FIG. 12 is a partial plan view schematically illustrating a conventional stripe-like color filter. As illustrated in the figure, colored layers 16R′, 16G′, and 16B′ of three colors extend in a vertical direction and each have a stripe shape. The colored layers 16R′, 16G′, and 16B′ are formed such that side. edges thereof overlap edges of a black matrix 41. Each width of lines which form the black matrix 41 is larger than each width of grooves 43′, and the colored layers 16R′, 16G′, and 16B′ are apart from one another. Grooves 43′ are formed in the vertical direction between the colored layers. On the other hand, in the vertical direction which is the direction in which the grooves 43′ extend, the colored layers 16R′, 16G′, and 16B′ are formed so as to ride on a black matrix 41′ extending in a lateral direction, and thus, at portions where the colored layers ride on the black matrix, there are upward convex swells due to thicknesses of the black matrix and the colored layers. Even after planarization by a planarizing film 14′, the upward swells can not be sufficiently planarized (see FIG. 6B referred to in the following).

Therefore, in a color liquid crystal display device using the color filter substrate, at portions which are not planarized sufficiently, abnormal orientation of liquid crystal is caused, which in turn causes leakage of light to decrease the contrast and the color reproducibility. Further, compared with a thickness of a liquid crystal layer at portions where there is only a color filter, a thickness of a liquid crystal layer at convex portions where the color filter rides on the black matrix is smaller, and thus, the liquid crystal is driven at relatively low voltage at those portions. Therefore, problems such as lowered color purity arise.

It should be noted that, around portions between the color filters for various colors where the grooves are formed on the black matrix, the planarization is satisfactory and such problems as lowered display quality do not arise.

The present invention has been made in view of the problem of lowered display quality, and it is an object of the present invention to provide a color filter substrate with satisfactory planarization by a planarizing film at any portion on a black matrix, a method of manufacturing the color filter substrate, and a liquid crystal display device having the color filter substrate.

### SUMMARY OF THE INVENTION

According to the present invention, there is provided a color filter substrate used for a color display device, including: a light shielding layer having a lattice-like portion formed in the lattice shape; colored layers of three different colors formed so as to partially overlap the light shielding layer; and a planarizing layer formed over the light shielding layer and the colored layers. The colored layers are partitioned into shapes corresponding to the lattice shape of the light shielding layer. Peripheral edges of the respective partitioned colored layers overlap the light shielding layer, and the peripheral edges have spaced portions therebetween. The planarizing layer is formed so as to fill the spaced portions and so as to overlap the light shielding layer.

According to the present invention, there is provided a method of manufacturing a color filter substrate including: a first step of forming a light shielding layer having a lattice-like portion in the lattice shape; a second step of forming colored layers of three different colors so as to partially overlap the light shielding layer; and a third step of forming a planarizing layer over the light shielding layer and the colored layers. In the second step, the colored layers of the three colors are formed to be partitioned into shapes corresponding to the lattice shape of the light shielding layer, and the peripheral edges thereof overlap the light shielding layer.

### BRIEF DESCRIPTION OF THE DRAWINGS

In the accompanying drawings:

FIG. 1 is a sectional view schematically illustrating a transmissive color liquid crystal display device according to the present invention;

FIG. 2 is a sectional view schematically illustrating a reflective color liquid crystal display device according to the present invention;

FIG. 3 is a sectional view schematically illustrating a semi-transmissive color liquid crystal display device according to the present invention;

FIG. 4 is a partial enlarged plan view of the color filter substrates illustrated in FIGS. 1, 2, and 3;

FIG. 5A is a partial enlarged view of FIG. 4;

FIG. 5B is a view of FIG. 5A with some portions thereof being omitted;

FIG. 6A is a sectional view taken along the line A-A in a range indicated by the lines B-B of FIG. 4;

FIG. 6B is a sectional view taken along the. line A-A in a range indicated by the lines B-B of FIG. 12;

FIGS. 7A and 7B are schematic enlarged views each illustrating a surface shape of a planarizing layer;

FIG. 8 is a flow chart of a part of a method of manufacturing the color filter substrate according to the present invention;

FIG. 9 is a partial enlarged plan view of another color filter substrate according to the present invention;

FIG. 10 is a partial enlarged plan view of still another color filter substrate according to the present invention;

FIG. 11 is a partial enlarged plan view of yet another color filter substrate according to the present invention; and

FIG. 12 is a partial plan view of a conventional color filter substrate.

### DETAILED DESCRIPTION OF THE PREFERRED EMBODIMENTS

A color filter substrate used for a color display device according to the present invention includes a light shielding layer having a lattice-like portion formed in the lattice shape, colored layers of a plurality of colors formed so as to partially overlap the light shielding layer, and a planarizing layer formed so as to cover the light shielding layer and the colored layers. The colored layers are partitioned into shapes corresponding to the lattice shape of the light shielding layer. Peripheral edges of the respective partitioned colored layers overlap the light shielding layer. Specifically, the respective partitioned colored layers have spaced portions formed therebetween. The planarizing layer is formed over the light shielding layer so as to fill the spaced portions.

Thus, the planarizing layer satisfactorily planarizes the surface of the color filter substrate. Therefore, by mounting the color filter substrate on a color liquid crystal display device, abnormal orientation of liquid crystal is decreased, leakage of light is decreased, and the contrast and the color reproducibility are satisfactory. In addition, because a thickness of a liquid crystal layer is substantially uniform, lowering of color purity is decreased. In order to attain this to a larger extent, the width of the spaced portions can be made larger by, for example, making larger the width of the light shielding layer.

Further, intersections of a lattice of the lattice-like portion may be formed to be wider than the other portions. In this case, the spaced portions at the intersections may be formed to be wider than the other spaced portions. Further, the lattice-like portion of the light shielding layer may be formed so as to partition a region corresponding to one pixel into three subregions. In this case, each of the subregions may be further partitioned into a plurality of regions. Further, the light shielding layer may have light shielding portions other than the lattice-like portion, and the colored layers may have discontinuous portions formed therein as openings which expose the light shielding portions. At the discontinuous portions, the colored layers are formed so as to overlap the light shielding portions, and the planarizing layer is formed over the light shielding layer so as to fill the discontinuous portions.

In the structure, the surface of the substrate is satisfactorily planarized by the planarizing layer. In order to attain further planarization, the number of partitioned subregions may be appropriately adjusted, and the number, size, shape, and distribution of the light shielding portions and of the discontinuous portions may be appropriately adjusted.

The color display device according to the present invention has the color filter substrate whose surface is satisfactorily planarized by the above-mentioned planarizing layer. Therefore, in the color liquid crystal display device to which the present invention is applied, abnormal orientation of liquid crystal is decreased, leakage of light is decreased, and the contrast and the color reproducibility are satisfactory. In addition, because the thickness of the liquid crystal layer is substantially uniform, lowering of the color purity is decreased. Therefore, high-quality display can be materialized. The color liquid crystal display device may be of any type including transmissive, reflective, and semi-transmissive types, and the present invention is used in an extremely wide variety of applications.

In a method of manufacturing a color display device according to the present invention, by a first step of forming a light shielding layer having a lattice-like portion in the lattice shape, a second step of forming colored layers of a plurality of colors so as to partially overlap the light shielding layer, and a third step of forming a planarizing layer so as to cover the light shielding layer and the colored layers, a color filter substrate is manufactured. The color filter substrate thus manufactured is used to manufacture the color display device. In the second step, the colored layers of the plurality of colors are formed to be partitioned into shapes corresponding to the lattice shape of the light shielding layer, and the peripheral edges thereof overlap the light shielding layer and such that spaced portions are formed therebetween. Therefore, a color filter substrate whose surface is satisfactorily planarized by the planarizing layer can be manufactured. In a color liquid crystal display device to which the color filter substrate is applied, abnormal orientation of liquid crystal is decreased, leakage of light is decreased, and the contrast and the color reproducibility are satisfactory. In addition, because the thickness of the liquid crystal layer is substantially uniform, lowering of the color purity is decreased. Photolithography may be used as the manufacturing method. Further, in order to attain this to a larger extent, the width of the spaced portions can be made larger by, for example, making larger the width of the light shielding layer in the first step or the like.

Further, in the first step, light shielding portions other than the lattice may be formed in the light shielding layer, and, in the second step, discontinuous portions may be formed in the colored layers of the plurality of colors as openings which expose the light shielding portions. As a result, at the discontinuous portions, the colored layers of the plurality of colors are formed so as to overlap the light shielding portions.

With the structure, a color display device having a color filter substrate whose surface is further satisfactorily planarized by the planarizing layer can be realized. Specifically, in a color liquid crystal display device to which the present invention is applied, abnormal orientation of liquid crystal is decreased, leakage of light is decreased, and the contrast and the color reproducibility are satisfactory. In addition, because the thickness of the liquid crystal layer is substantially uniform, lowering of the color purity is decreased. In order to attain this to a larger extent, the number, size, shape, and distribution of the light shielding portions and of the discontinuous portions may be appropriately adjusted.

Further, the third step may include: an applying step of applying a first liquid for forming the planarizing layer sodas to cover the light shielding layer and the colored layers; a leveling step of leveling the applied first liquid at portions where the first liquid covers the light shielding layer and at the other portions; and an immobilizing step of immobilizing the first liquid after the leveling step. As a result, a display device having a color filter substrate whose surface thereof is satisfactorily planarized can be manufactured. Therefore, in a color liquid crystal display device to which the present invention is applied, abnormal orientation of liquid crystal is decreased, leakage of light is decreased, and the contrast and the color reproducibility are satisfactory. In addition, because the thickness of the liquid crystal layer is substantially uniform, lowering of the color purity is decreased. Further, by appropriately adjusting a time period for the leveling step according to the viscosity of the first liquid, a width of the spaced portions, the wettability of the light shielding layer and the colored layers with the first liquid, the temperature of the atmosphere, and the like, the effect can be further enhanced.

### EXAMPLES

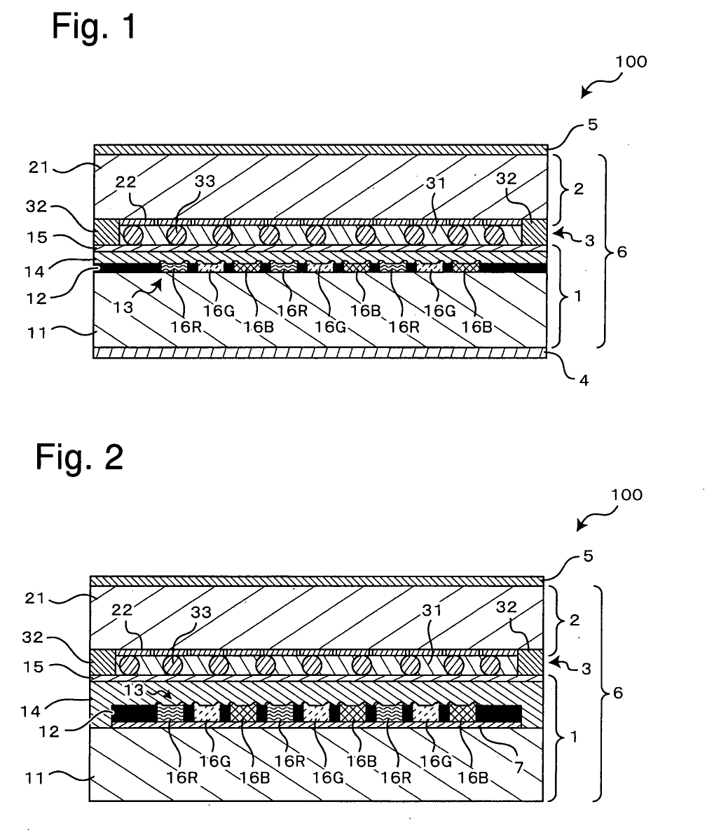

Examples of the present invention are described in the following with reference to the attached drawings. FIG. 1 is a sectional view of a color filter substrate 1 of this example and a transmissive color liquid crystal display device having the same. A color liquid crystal display device 100 includes the color filter substrate 1, an opposing substrate 2 disposed so as to oppose the color filter substrate 1, a liquid crystal layer 3 formed between the color filter substrate 1 and the opposing substrate 2, a lower polarizing plate 4 disposed outside the color filter substrate 1, and an upper polarizing plate 5 disposed outside the opposing substrate 2.

The color filter substrate 1 includes a transparent substrate 11 formed of glass, a black light shielding layer 12 formed on a surface of the transparent substrate 11 on the side of the liquid crystal layer 3, a color filter 13 formed so as to be substantially flush with the light shielding layer 12, a planarizing film 14 as a planarizing layer which is a top coat formed over the light shielding layer 12 and the color filter 13, a transparent electrode 15 formed in a predetermined pattern on a surface of the planarizing film 14 on the side of the liquid crystal layer 3, and an oriented film formed of a polyimide (not shown) provided on a surface of the transparent electrode 15 on the side of the liquid crystal layer 3. The opposing substrate 2 includes a transparent substrate 21 formed of glass, an opposing transparent electrode 22 formed in a predetermined pattern on a surface of the transparent substrate 21 on the side of the liquid crystal layer 3, and an oriented film (not shown) provided on a surface of the opposing transparent electrode 22 on the side of the liquid crystal layer 3. In this case, the liquid crystal layer 3 is formed of a liquid crystal 31 encapsulated between the color filter substrate 1 and the opposing substrate 2, a sealing material 32 for encapsulating the liquid crystal 31 between the color filter substrate 1 and the opposing substrate 2 and for setting a distance between the color filter substrate 1 and the opposing substrate 2 to a predetermined distance, and spacers 33 disposed between the transparent electrode 15 and the transparent electrode 22 for, together with the sealing material 32, setting the distance between the color filter substrate 1 and the opposing substrate 2 to a predetermined distance.

The color filter substrate 1, the opposing substrate 2, and the liquid crystal layer 3 form a display panel 6. The polarizing plate 4 and the polarizing plate 5 are disposed in a pair so as to sandwich the display panel 6. The color filter 13 has colored layers 16R, 16G, and 16B of red (R), green (G), and blue (B), respectively, of the primary colors of light such that transmitted light is colored with the colors of the respective colored layers 16R, 16G, and 16B. The pattern of the colored layers 16R, 16G, and 16B is periodically repeated a plurality of times in a lateral direction of FIG. 1. It should be noted that the color filter 13 may be a color filter of magenta, yellow, and cyan instead of red (R), green (G), and blue (B).

Because the color liquid crystal display device 100 is a passive liquid crystal display device, the transparent electrode 15 is formed as common lines in a pattern so as to intersect the lateral direction of FIG. 1 in which the colored layers 16R, 16G, and 16B are periodically disposed. When the color liquid crystal display device 100 is an active liquid crystal display device, no patterning is necessary and the shape of the electrode may be in its natural state as is formed using a mask.

FIG. 2 is a sectional view of a reflective color liquid crystal display device 100 as another example. As illustrated in the figure, the color liquid crystal display device 100 does not necessarily have to be the transmissive type as illustrated in FIG. 1 and may be a reflective type. Identical members of the transmissive color liquid crystal display device 100 illustrated in FIG. 1 are denoted by the same reference symbols, and description thereof is omitted. The reflective color liquid crystal display device 100 has a metallic reflective film 7 as a reflective layer for reflecting light from the outside, which is provided between the light shielding layer 12 and the colored layers, and the transparent substrate 11. The reflective color liquid crystal display device 100 does not have the polarizing plate 4 of the transmissive color liquid crystal display device 100 illustrated in FIG. 1. The upper polarizing plate 5 may additionally have a ¼ wavelength plate for making in-phase light which is reflected from the metallic reflective film 7 and is out of phase, and a layer having a scattering function for preventing glare of light regularly reflected from the metallic reflective film 7.

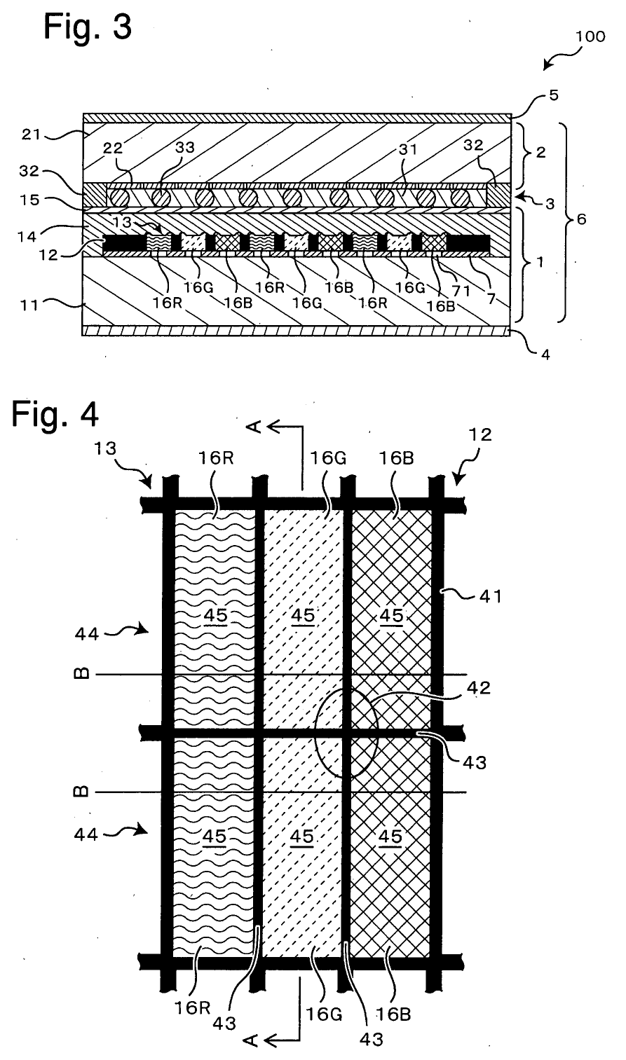

FIG. 3 is a sectional view of a semi-transmissive color liquid crystal display device 100 as still another example. As illustrated in FIG. 3, the color liquid crystal display device 100 does not necessarily have to be the transmissive type as illustrated in FIG. 1 or the reflective type illustrated in FIG. 2, and may be a semi-transmissive type. Identical members of the color liquid crystal display device 100 illustrated in FIG. 1 and FIG. 2 are denoted by the same reference symbols, and description thereof is omitted appropriately. The metallic reflective film 7 of the semi-transmissive color liquid crystal display device 100 has holes 71 formed therein by removing a part of portions corresponding to the colored layers 16R, 16G, and 16B. This gives the colored layers 16R, 16G, and 16B functions both as reflective portions and transmissive portions.

In the color liquid crystal display devices 100 having those structures, the light shielding layer 12, the color filter 13, the planarizing film 14, and the transparent electrode 15 are formed in a similar pattern. In this regard, the structure of the color filter substrate 1 is common to all the color liquid crystal display devices 100.

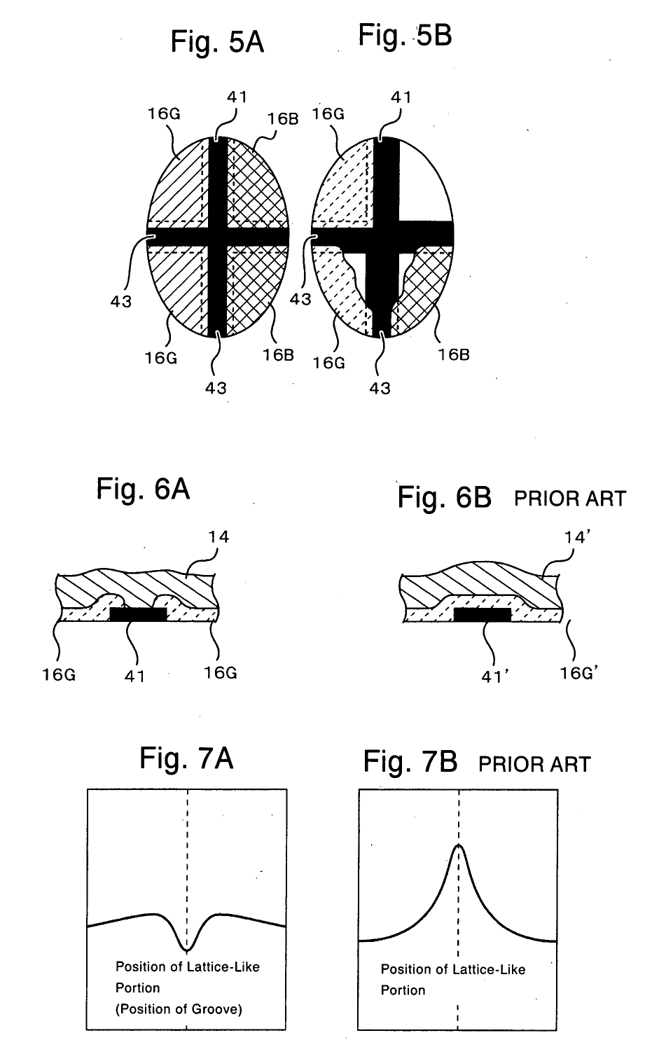

FIG. 4 is an enlarged plan view of a part of a pattern in which the light shielding layer 12 and the colored layers are formed of the common structure. A lateral direction of FIG. 4 corresponds to the lateral direction of FIGS. 1 to 3. It should be noted that a black matrix 41 of the light shielding layer 12 is actually seen through the colored layers 16R, 16G, and 16B as black when seen from a front side of FIG. 4, and thus, edges of the colored layers 16R, 16G, and 16B can not be seen. However, for the sake of convenience, FIG. 4 illustrates the black matrix 41 as if the black matrix 41.were covered with the colored layers 16R, 16G, and 16B such that the whole color filter is clearly seen. This is the same in FIGS. 5, 9, and 11 referred to in the following.

The light shielding layer 12 has the black matrix 41 as a lattice-like portion formed in the lattice shape. The black matrix 41 prevents color mixture of light which passes through the colored layers 16R, 16G, and 16B. The colored layers 16R, 16G, and 16B of the color filter 13 corresponds to the shape of the black matrix 41, and are rectangular and geometrically similar to the shape of the inner peripheral edges of the black matrix 41 and are formed to be island-like to be partitioned off from one another.

FIG. 5 is enlarged plan views of a region denoted by reference numeral 42 of FIG. 4. FIG. 5A is a plan view of the region 42 simply enlarged, while FIG. 5B is an enlarged view of the region with a part of the colored layers 16G and 16B omitted. In FIG. 5, broken lines show the outline of the black matrix 41 located below the colored layers in FIG. 5. As shown in the figure, the colored layers 16R, 16G, and 16B are formed such that peripheral edges thereof ride on edges of the black matrix 41 so as to overlap the black matrix 41. Portions in which both the light shielding layer 12 and the colored layers 16 are formed in this way in order to prevent defective pixels and the like. The peripheral edges of the colored layers 16R, 16G, and 16B are apart from one another, and grooves 43 as spaced portions are formed in vertical and lateral directions in the lattice shape corresponding to the shape of the black matrix 41. The width of lines which form the black matrix 41 is larger than the width of the grooves 43.

As illustrated in FIG. 4, a group of the colored layers 16R, 16G, and 16B forms a region 44 corresponding to one pixel. In FIG. 4, only two regions 44 arranged in a vertical direction are illustrated, but the color filter substrate 1 has a plurality of the regions 44, in the vertical and lateral directions in FIG. 4. FIG. 4 shows two such regions 44 arranged in the vertical direction each formed of a group of the colored layers 16R, 16G, and 16B and the black matrix 41 partitioning the colored layers and each corresponding to one pixel. The two regions 44 are laterally partitioned into two by the black matrix 41. The black matrix 41 further partitions each of the regions 44 into three subregions 45 which correspond to red (R), green (G) , and blue (B) formed by the colored layers 16R, 16G, and 16B, respectively. Each of the subregions 45 is referred to as a dot.

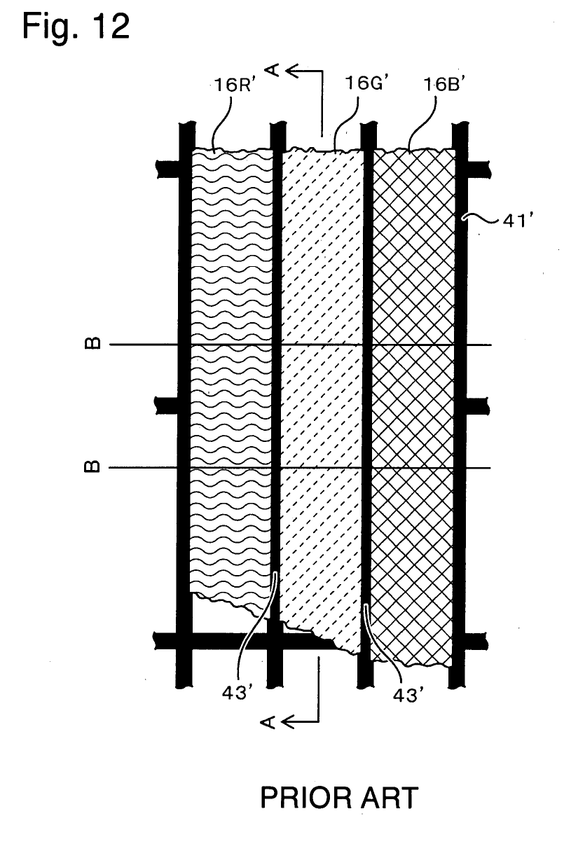

As described above, the colored layers 16R, 16G, and 16B are rectangular, in other words, strip-like which are geometrically similar to the shape of the inner peripheral edges of the black matrix 41 partitioned into the subregions 45. As described above, in the conventional color filter illustrated in FIG. 12, because the colored layers 16R′, 16G′, and 16B′ are formed so as to ride on the black matrix 41′, at those portions, as illustrated in FIG. 6B, there are upward convex swells due to the thicknesses of the black matrix 41′ and the colored layers. Therefore, even if the planarizing film 14′ is provided, the upward swells can not be sufficiently planarized. In this case, FIG. 6 is schematic views illustrating a section where the black matrix and the colored layers overlap. FIG. 6A is a sectional view taken along the line A-A in a range of B-B in FIG. 4 while FIG. 6B is a sectional view taken along the line A-A in a range indicated by the lines B-B of FIG. 12.

Therefore, in a color liquid crystal display device including the conventional color filter substrate, at portions which are not sufficiently planarized, abnormal orientation of liquid crystal is caused, which in turn causes leakage of light to decrease the contrast and the color reproducibility. Further, as compared with the thickness of the liquid crystal layer at portions where there are only the colored layers, the thickness of the liquid crystal layer at convex portions where the colored layers ride on the black matrix is smaller, and thus, the liquid crystal is driven at relatively low voltage at those portions. Therefore, problems such as lowered color purity arise.

Accordingly, in the color filter substrate 1, as described above, the color filter 13 is formed such that the grooves 43 are formed at all portions on the black matrix 41 between the colored layers for each color. Therefore, as illustrated in FIG. 6A, the planarizing film 14 is formed over the black matrix 41 so as to fill the grooves 43. The surface of the planarizing film 14 is formed in a gentler shape, as compared with the surface of the conventional planarizing film 14′ illustrated in FIG. 6B, and thus, such problems do not arise.

Comparison between the surface shape of the planarizing film 14 and the surface shape of the planarizing film 14′ is described in detail. FIG. 7 and Table 1 show the result of measurement of the surface shape of the planarizing films 14 and 14′. FIGS. 7A and 7B are schematic views of the surface shapes of the planarizing films 14 and 14′ exaggerated as described in the following, respectively. In FIG. 7, the vertical axis represents the height of the surface of the planarizing film 14 or 14′ while the lateral axis represents the distance from the black matrix 41 or 41′. For example, the vertical direction and the lateral direction of FIGS. 7A and 7B correspond to the vertical and lateral directions of FIGS. 6A and 6B, respectively. In FIGS. 7A and 7B, the positions indicated by the broken lines correspond to the center positions in the width direction of the black matrices 41 and 41′, respectively. The vertical axis scale of FIG. 7 is enlarged compared with the vertical axis scale in FIG. 6 while the lateral axis scale of FIG. 7 is reduced as compared with the lateral axis scale of FIG. 6, thereby exaggerating the surface shapes of the planarizing films 14 and 14′, respectively. Actually, the surface shapes of the planarizing films 14 and 14′ are in a pattern where the surface shapes illustrated in FIGS. 7A and 7B are repeated in the lateral direction, respectively.

TABLE 1
(Unit: □m)

| | | | | Comparative | | |
|---|---|---|---|---|---|---|
| | Example | | | example | | |
| Sample No. | 1 | 2 | 3 | 4 | 5 | 6 |
| R line | 0.06 | 0.02 | 0.04 | 0.11 | 0.16 | 0.16 |
| G line | 0.02 | 0.05 | 0.03 | 0.15 | 0.16 | 0.17 |
| B line | 0.07 | 0.05 | 0.02 | 0.17 | 0.14 | 0.16 |

| | | |
|---|---|---|
| Average | 0.04 | 0.15 |

In Table 1, the respective values represent difference in height between a peak position and a bottom position illustrated in FIG. 7 of the planarizing film. In Table 1, each item of Example corresponds to differences in height of the surface of the planarizing film 14 illustrated in FIG. 7A, while each item of Comparative Example corresponds to differences in height of the surface of the planarizing film 14′ illustrated in FIG. 7B. In this case, the thickness of the black matrix 41 was 1.2 [symbol] m, the thickness of the colored layers 16R, 16G, and 16B was 1.3 [symbol] m, the film thickness of the planarizing film 14 was 2.8 [symbol] m, and a film thickness meter DETAK (trade name) was used to make measurements. It should be noted that the black matrix 41 and the respective colored layers 16R, 16G, and l6B were formed so as to have a film thickness of 0.5 to 1.5 μm from the viewpoint of light shielding and color reproductivity. As shown in Table 1, the average of the differences in height is decreased to 0.04 μm as compared with the conventional one of 0.15 [symbol] m, which is a drastic improvement.

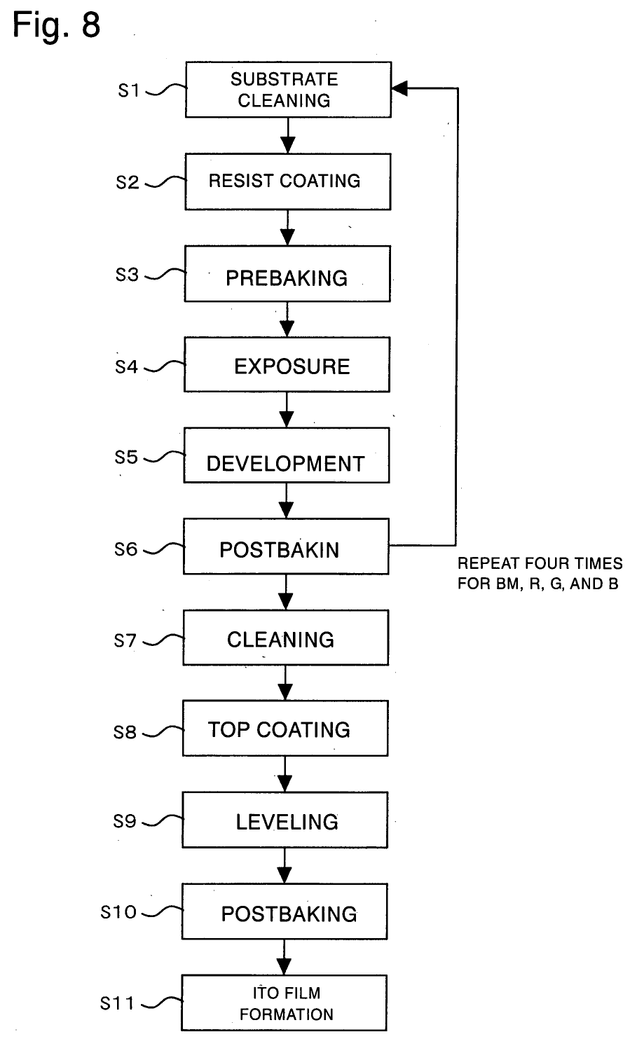

The drastic improvement can be attained because, in a step of forming the planarizing film 14 on the light shielding layer 12 and the colored layers 16 after the light shielding layer 12 and the colored layers 16 are formed, a liquid applied for forming the planarizing film 14 flows in to fill the grooves 43, and thus, a portion which conventionally forms a peak as illustrated in FIG. 7B is bowed inward as illustrated in FIG. 7A. Next, a method of manufacturing the color filter substrate 1 as an example of the present invention is described with reference to FIG. 8 which is a flow chart of a part of the manufacturing method.

When the light shielding layer 12, the colored layers 16, and the planarizing film 14 are formed, first, as illustrated in FIG. 8, a step of cleaning the substrate is carried out (S1). In this case, cleaning at the step of cleaning the substrate is carried out with respect to the transparent substrate 11 in the case of the transmissive color liquid crystal display device illustrated in FIG. 1, with respect to the transparent substrate 11 having the metallic reflective film 7 formed thereon in the case of the reflective color liquid crystal display device illustrated in FIG. 2, and with respect to the transparent substrate 11 having the metallic reflective film 7 with holes 71 formed thereon in the case of the semi-transmissive color liquid crystal display device illustrated in FIG. 3.

It should be noted that the metallic reflective film 7 is formed thick enough to prevent light from passing therethrough by a vacuum film formation method such as a sputtering. method or vacuum deposition method. In order to shield light sufficiently, the film thickness of the metallic reflective film 7 is at least 0.10 [symbol] m. When the metallic reflective film 7 is made of aluminum or an aluminum alloy, the film thickness is typically about 0.125 [symbol] m. When the metallic reflective film 7 is made of silver or a silver alloy, the film thickness is typically about 0.10 [symbol] m.

The holes 71 are formed by patterning the metallic reflective film 7 such that the reflective portions and transmissive portions are formed by photolithography, and by removing predetermined portions by etching.

After the step of cleaning the substrate (S1), resist coating is carried out (S2). In this case, a liquid photoresist is applied. The photoresist is a pigment-dispersed resist which is a photosensitive acrylic resin mixed with a pigment or the like in accordance with the color of the layer to be formed, that is, black for the light shielding layer 12 and R, G, and B for the colored layers 16R, 16G, and 16B for the color filter 13.

After the resist coating (S2), prebaking is carried out (S3). Then, exposure to light is carried out in a predetermined pattern (S4) to cure the resist, development is carried out (S5) to remove the resist which is not cured, and postbaking is carried out (S6) at 230° C. to completely immobilize the liquid.

The steps S1 to S6 are repeated four times in this order so that the light shielding layer 12 and the colored layers 16R, 16G, and 16B are formed by photolithography. In FIG. 8, BM represents the light shielding layer 12, R represents the red colored layer 16R, G represents the green colored layer 16G, and B represents the blue colored layer 16B.

When the steps S1 to S6 are carried out to form the light shielding layer 12 (first step), of patterning of the exposure to light is carried out such that the black matrix 41 is formed. When the steps S1 to S6 are carried out to form the colored layer 16R, the colored layer 16G, and the colored layer 16B (second step), patterning of the exposure to light is carried out such that the island-like shapes and the grooves 43 described in the above are formed at the predetermined positions, respectively.

After the steps S1 to S6 are repeated four times to form the light shielding layer 12 and the colored layers of the three colors, in order to form the planarizing film 14 (third step), the substrate is cleaned (S7), and then, a liquid thermosetting acrylic resin or a composite resin of the acrylic resin and an epoxy resin is used to carry out an applying step, that is, to form the top coat (S8). The top coat is formed so as to cover the light shielding layer 12 and the colored layers 16. Then, the liquid resin fills the grooves 43, and, in order to level the portions where the liquid resin covers the light shielding layer 12, that is, portions on the periphery of the grooves 43, and other portions, for example, portions of only the colored layer 16R, 16G, or 16B, a leveling step is carried out (S9). In the leveling step, leveling is appropriately carried out according to the viscosity of the resin, the width of the grooves 43, the wettability of the light shielding layer 12 and the color filter 13 with the resin, the temperature of the atmosphere, and the like, and there is a wait until a predetermined time period is allowed to pass so that a satisfactory state as illustrated in FIG. 7A and Table 1 is obtained.

After appropriate leveling is carried out at the leveling step (S9), in order to immobilize the resin in this state, postbaking (S10) is carried out to form the planarizing film 14. The planarizing film 14 not only levels the light shielding layer 12 and the color filter 13, but also secures adherence and resistance to patterning of the transparent electrode 15.

After the planarizing film 14 is formed, the transparent electrode 15 is formed by film formation (S11). The transparent electrode 15 is formed by sputtering so as to have a desired film thickness and desired resistance characteristics. As the transparent electrode 15, a conductive material formed of indium (In) tin (Sn) oxide is used. Further, the oriented film is formed by offset printing to form the color filter substrate 1.

In this way, the color filter substrate 1 is formed. The color filter substrate 1 is used to form the color liquid crystal display device 100 illustrated in FIGS. 1 to 3. Specifically, by forming the transparent electrode 22 similarly to the transparent electrode 15 on the transparent substrate 21, the opposing substrate 2 is formed. The spacers 33 are distributed uniformly by a scattering method, the sealing material 32 is formed by screen printing, the color filter substrate 1 and the opposing substrate 2 are bonded to each other, and the liquid crystal 31 is injected into the space formed between the color filter substrate 1 and the opposing substrate 2 to form the liquid crystal layer 3, thereby forming the color liquid crystal display device. The polarizing plates 4 and 5 are formed on the color filter substrate 1 and the opposing substrate 2, respectively, at appropriate times.

Therefore, in the color liquid crystal display device having the color filter substrate 1 as described above, because the surface of the color filter substrate 1 is satisfactorily planarized by the planarizing film 14, abnormal orientation of the liquid crystal 31 is decreased, and thus, leakage of light is decreased, and the contrast and the color reproducibility are satisfactory. In addition, because the thickness of the liquid crystal layer 3 is substantially uniform, lowering of the color purity is decreased, and thus, a Whole image is satisfactorily displayed.

As already described, the planarization can be satisfactorily carried out using the planarizing film 14 because, when the planarizing film 14 is formed the resin for forming the planarizing film 14 flows in so as to fill the grooves 43. Therefore, the larger the area or the volume of the grooves 43 is, the larger the amount of the resin which flows in becomes, and thus, the planarization is carried out more satisfactorily. However, if the depth of the grooves 43 is made large, the unevenness or the roughness of the color filter 13 becomes larger due to the large depth of the grooves 43 itself, which is not preferable. Accordingly, in order to make larger the amount of the resin which flows in, it is preferable to make larger the area of the grooves 43. However, if the area where the color filter 13 is formed is made smaller and the number of areas where the light shielding layer 12 and the color filter 13 overlap is made small in order to make larger the area of the grooves 43, defective pixels and the like are more liable to occur. Accordingly, in order to make larger the area of the grooves 43, it is preferable to make larger the area of the light shielding layer 12.

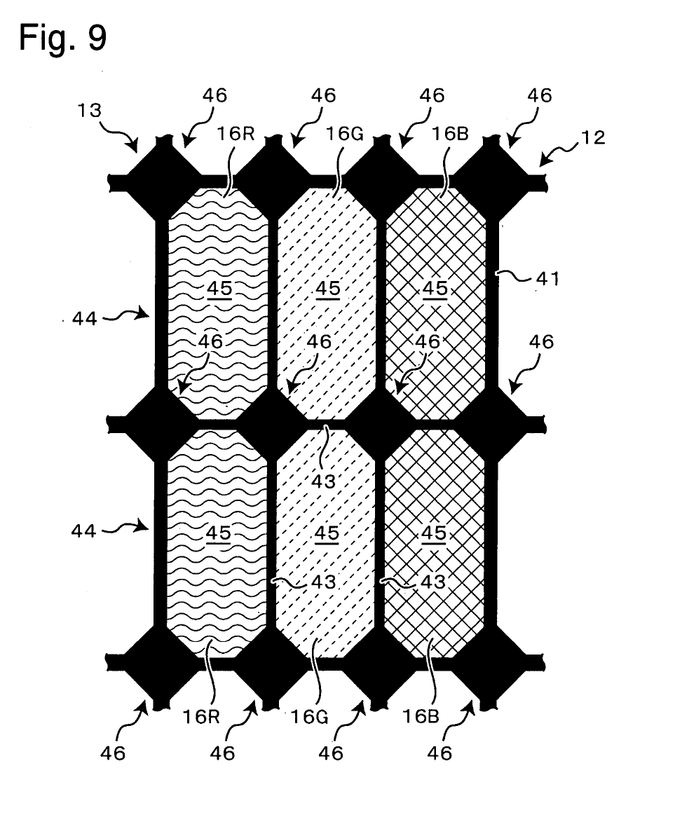

FIG. 9 is a partial plan view of a pattern in which the light shielding layer 12 and the colored layers 16 are formed according to another example taking the above into consideration. The pattern illustrated in FIG. 9 in which the light shielding layer 12 and the colored layers 16 are formed can be adopted in the color filter substrate 1 instead of the pattern illustrated in FIG. 4 in which the light shielding layer 12 and the colored layers 16 are formed. In FIG. 9, similarly to the case illustrated in FIG. 4, two regions 44 each formed of a set of the colored layers 16R, 16G, and 16B and the black matrix 41 partitioning them and each corresponding to one pixel are arranged in the vertical direction. The two regions 44 are partitioned into top and bottom by the black matrix 41.

In this case, portions 46 of the light shielding layer 12 where the lattice of the black matrix 41 intersects are formed to be wider than other portions, and four corners of the colored layers 16R, 16G, and 16B are cut off in a taper shape, respectively. Such a structure makes larger the area of the grooves 43 and makes larger the amount of the resin for forming the planarizing film 14 to flow in, and the surface of the planarizing film 14 is more easily planarized.

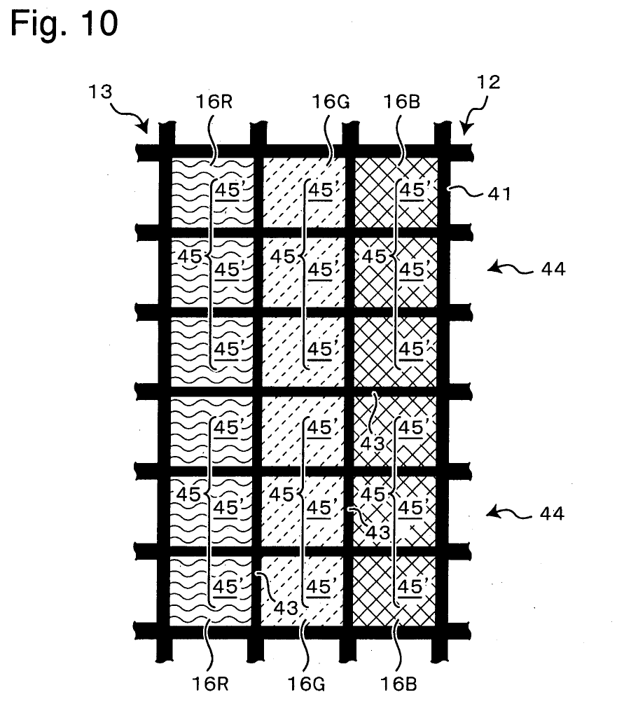

FIG. 10 is a partial plan view of a pattern in which the light shielding layer 12 and the colored layers 16 are formed according to still another example taking the above into consideration. The pattern illustrated in FIG. 10 in which the light shielding layer 12 and the colored layers 16 are formed can be adopted in the color filter substrate 1 instead of the patterns illustrated in FIGS. 4 and 9 in which the light shielding layer 12 and the colored layers 16 are formed. In FIG. 10, two regions 44 are each corresponding to one pixel arranged in the vertical direction. The two regions 44 are partitioned into top and bottom by the black matrix 41.

In this case, the black matrix 41 of the light shielding layer 12 equally partitions each of the subregions 45 arranged in two rows and three columns in FIG. 10 into three in a vertical direction to subpartition the subregions. The minimum unit obtained by the subpartitioning is referred to as subdot or subpixel, which is illustrated as a region 45′ in the figure. The shapes of the colored layers 16R, 16G, and 16B corresponds to the shape of each of the regions 45′, and are rectangular and geometrically similar to the shape of the inner edges of the black matrix 41 such that the edges thereof overlap the black matrix 41.

By subpartitioning the respective colored layers 16R, 16G, and 16B by the black matrix 41 in this way, the area of the grooves 43 can be increased. By increasing the area of the grooves 43, the amount of the resin for forming the planarizing film 14 to flow in is increased, and the surface of the planarizing film 14 is more easily planarized. With such shape of the grooves 43, because the distribution of the grooves 43 is more even, the resin flows in more evenly, the planarization is carried out more evenly, and thus, the planarization of the surface of the planarizing film 14 is carried out satisfactorily.

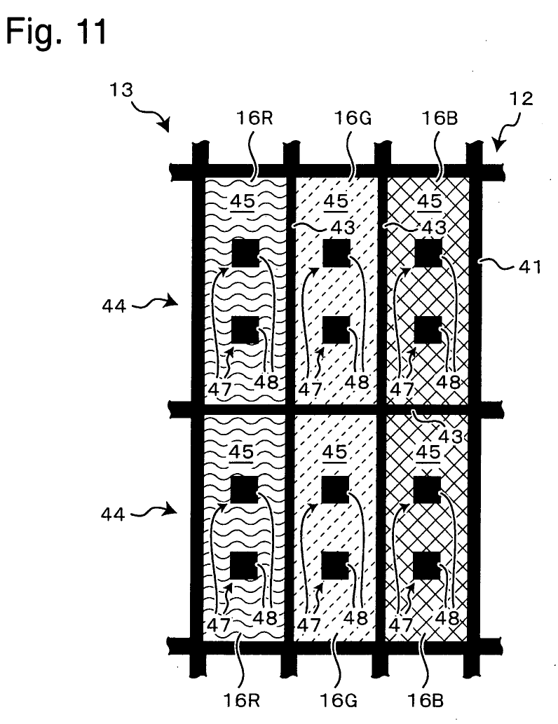

FIG. 11 is a partial plan view of a pattern in which the light shielding layer 12 and the colored layers 16 are formed according to yet another example taking the above into consideration. The pattern illustrated in FIG. 11 in which the light shielding layer 12 and the colored layers 16 are formed can be adopted in the color filter substrate 1 instead of the patterns illustrated in FIGS. 4, 9, and 10 in which the light shielding layer 12 and the colored layers 16 are formed. In FIG. 11, similarly to the case illustrated in FIG. 4, two regions 44 each formed of a set of the colored layers 16R, 16G, and 16B and the black matrix 41 partitioning them and each corresponding to one pixel are arranged in the vertical direction. The two regions 44 are partitioned into top and bottom by the black matrix 41. In this case, the light shielding layer 12 has other light shielding portions 47 independent of the black matrix 41. The light shielding portions 47 have a square shape and are disposed in the middle of the respective subregions 45.

In this case, the colored layers 16R, 16G, and 16B are formed such that their edges overlap the light shielding portions 47 as in the case of the black matrix 41. However, in order to increase the amount of the resin for forming the planarizing film 14 to flow in, the colored layers 16R, 16G, and 16B formed so as to overlap the light shielding portions 47 are formed such that center portions of the surface of the light shielding portions 47 form discontinuous portions 48 exposed to the planarizing film 14. Therefore, the colored layers 16R, 16G, and 16B are formed in a shape corresponding to the shape of the light shielding layer 12 having the black matrix 41 and the discontinuous portions 48.

The area of the light shielding layer 12 which is exposed to the planarizing film 14 becomes larger because of the discontinuous portions 48 in addition to the grooves 43, and thus, the amount of the resin for forming the planarizing film 14 to flow in is increased and the surface of the planarizing film 14 is more easily planarized. With such shape of the grooves 43, because the distribution of the portions which are exposed to the planarizing film 14 and are formed by the grooves 43 and the discontinuous portions 48 is more even, the resin flows in more evenly, the planarization is carried out more evenly, and thus, the planarization of the surface of the planarizing film 14 is carried out satisfactorily.

When such a pattern is formed, in the above-mentioned first process, that is, in S1 to S6 regarding the light shielding layer 12, patterning is carried out so as to form, in addition to the black matrix 41, the light shielding portions 47, and in the second process, that is, in S1 to S6 regarding the color filter 13, patterning is carried out such that the colored layers 16R, 16G, and 16B overlap the light shielding portions 47 as described above, and such that the light shielding portions 47 are exposed to the planarizing film 14. In other words, patterning is carried out such that the discontinuous portions 48 are formed.

Further, in the leveling step (S9), in addition to leveling by the grooves 43 as described above, leveling is appropriately carried out according to the viscosity of the resin, the shape and area of the discontinuous portions 48, the wettability of the light shielding layer 12 and the colored layers 16 with the resin, the temperature of the atmosphere, and the like such that the resin for forming the planarizing film 14 fills the discontinuous portions 48 and such that the portions which overlap the discontinuous portions 48, that is, portions on the periphery of the discontinuous portions 48, and other portions, for example, portions of only the colored layer 16R, 16G, or 16B are leveled. After that, a predetermined time period is allowed to pass so that a satisfactory state similarly to the state illustrated in FIG. 7A and Table 1 is obtained.

The grooves 43 and the discontinuous portions 48 preferably increase the area of the light shielding layer 12 exposed to the planarizing film 14, and their distribution is preferably as even as possible. In view of the above, insofar as the object is attained, the light shielding portions 47 and the discontinuous portions 48 may be in any shape including a square, a rectangle, and a circle, and their number is not limited to two and may be one or three or more. The light shielding portions 47 and the discontinuous portions 48 maybe formed so as to extend from the black matrix 41 to the grooves 43, respectively. In so far as a subregion 45 has a plurality of the regions 45′ provided therein, the number of the regions 45′ included in the subregion 45 is not limited to three, and may be two or four or more.

Insofar as the above object is attained, the whole black matrix 41 may be made wide, and the patterns illustrated in FIGS. 9 to 11 and other patterns described above may be appropriately combined. However, if the area of the light shielding layer 12 is too large, the amount of the resin which flows in becomes too large, and problems such as an adverse effect on the planarization, and darkening of the display screen arise. Therefore, it is preferable that the ratio of the area of the light shielding layer 12 to the area of an image display region formed of all the regions 44 corresponding to one pixel be kept at 7 to 8%.

As described above, according to the present invention, the planarity of the planarizing, layer formed on the light shielding layer and the colored layers of the color filter substrate is improved. Therefore, by mounting the color filter substrate on a color liquid crystal display device, abnormal orientation of liquid crystals is decreased, leakage of light can be reduced, and the contrast and the color reproducibility are satisfactory. In addition, because the thickness of the liquid crystal layer is substantially uniform, lowering of the color purity can be suppressed.

Further, according to the method of manufacturing a color filter substrate according to the present invention, a color filter substrate the surface of which is satisfactorily planarized can be manufactured. Therefore, abnormal orientation of liquid crystals is decreased, leakage of light can be decreased, and the contrast and the color reproducibility are satisfactory. In addition, because the thickness of the liquid crystal layer is substantially uniform, lowering of the color purity can be suppressed.

What is claimed is:

1. A color display device, comprising:
a light shielding layer having a lattice-like portion formed in a lattice shape;
colored layers of a plurality of colors formed so as to overlap the light shielding layer; and
a planarizing layer formed so as to cover the light shielding layer and the colored layers, wherein:
the colored layers are partitioned into a shape corresponding to the lattice shape of the light shielding layer;
edges of the respective partitioned colored layers partially overlap the light shielding layer, and the edges have spaced portions formed therebetween so that the edges are apart from each other; and
the planarizing layer is formed over the light shielding layer so as to fill the spaced portions.

2. A color display device according to claim 1, wherein:
intersections of a lattice of the lattice-like portion are formed to be wider than the other portions; and
the spaced portions at the intersections are formed to be wider than the other spaced portions.

3. A color display device according to claim 1, wherein the lattice-like portion of the light shielding layer is formed so as to partition a region corresponding to one pixel into three subregions corresponding to three colors, respectively, and each of the subregions is partitioned into a plurality of regions.

4. A color display device according to claim 1, wherein:
the light shielding layer has light shielding portions other than the lattice-like portion;
the colored layers have discontinuous portions formed therein as openings which expose the light shielding portions, and, at the discontinuous portions, the colored layers are formed so as to overlap the light shielding portions; and
the planarizing layer is formed over the light shielding layer so as to fill the discontinuous portions.

5. A method of manufacturing a color display device using a color filter substrate, comprising:
a first step of forming a light shielding layer having a lattice-like portion in the lattice shape;
a second step of forming colored layers of a plurality of colors so as to partially overlap the light shielding layer; and
a third step of forming a planarizing layer so as to cover the light shielding layer and the colored layers to manufacture the color filter substrate,
wherein, in the second step, the colored layers of the plurality of colors are partitioned into shapes corresponding to the lattice shape of the light shielding layer, and are formed such that edges thereof overlap the light shielding layer and such that spaced portions are formed between the colored layers.

6. A method of manufacturing a color filter substrate according to claim 5, wherein:
the first step comprises forming light shielding portions other than the lattice in the light shielding layer; and
the second step comprises forming discontinuous portions in the colored layers of the plurality of colors as openings which expose the light shielding portions, to thereby form the colored layers of the plurality of colors so as to overlap the light shielding portions at the discontinuous portions.

7. A method of manufacturing a color display device according to claim 5, wherein the third step comprises:
an applying step of applying a first liquid for forming the planarizing layer so as to cover the light shielding layer and the colored layers;
a leveling step of leveling the applied first liquid at portions of the first liquid which overlaps the light shielding layer and at other portions thereof; and
an immobilizing step of immobilizing the first liquid after the leveling step.
